(19) United States
(12) Patent Application Publication
(10) Pub. No.: US 2021/0319404 A1
(43) Pub. Date: Oct. 14, 2021

(54) HUMAN RESOURCE INFORMATION UTILIZATION SYSTEM AND OPERATION METHOD OF SAME

(71) Applicant: WHOIS SYSTEM CO., LTD., Seoul (KR)

(72) Inventor: Chung Jong LEE, Gangwon-do (KR)

(21) Appl. No.: 17/276,954

(22) PCT Filed: Sep. 18, 2019
(86) PCT No.: PCT/KR2019/012054

§ 371 Date: Mar. 17, 2021

(30) Foreign Application Priority Data
Sep. 19, 2018 (KR) 10-2018-0112348

(51) Int. Cl. G06Q 10/10; G06Q 10/06; G06Q 30/02; G06F 16/21; G06F 21/60

(52) U.S. Cl. CPC G06Q 10/105; G06Q 10/06398; G06Q 10/06393; G06Q 2220/00; G06F 16/21; G06F 21/602; G06Q 30/0218

(57) ABSTRACT

A human resource information utilization system which includes a central server for managing human resource information, wherein the central server: receives the registration of an institution and individuals belonging to the institution as members; generates a unique ID for each individual performing work in the institution; receives, from the institution, the input of human resource information at each preset interval; analyzes the human resource information and thus classifies the human resource information into individually-performed basic work information and project information; and constructs a database to store the classified basic work information and project information together with the corresponding unique ID of each individual, the basic work and project information on individuals provided by the institution being acquired and then stored in the database, thus making it possible to acquire human resource information that is of greater quantity and more complete than in the past.

### BACKGROUND OF THE DISCLOSURE

### Field of the Disclosure

The present disclosure relates to a human resource information utilization system and a method for operating the system, and more particularly, to a human resource information utilization system capable of utilizing highly credible human resource information by acquiring human resource information on individuals directly from an institution registered to the system and a method for operating the system.

### Related Art

Recently, recruiters or job seekers perform recruiting or job searches through a method in which institutions or individuals register their information directly to an online platform related to employment. In this kind of method, the credibility of human resource information (for example, project experiences) related to employment relies entirely on the individuals who register their human resource information. In other words, all of the current online platforms related to employment provide human resource information simply as registered by an individual even if the individual enters his or her human resource information poorly and thus, fail to offer a means to validate the credibility of the human resource information. Therefore, it is difficult to get abundant information on an individual; since recruiting and job search are performed based on human resource information of low credibility, there has been a problem that job matching is not successful for both a company trying to find a competent person and an individual seeking a job position.

### SUMMARY

To solve the problem above, the present disclosure is intended to provide a human resource information utilization system capable of providing human resource information of high credibility and a method for operating the system, where an institution registers results of basic tasks and projects performed by an individual through a platform provided by the system of the present disclosure managing human resource information.

According to various embodiments of the present disclosure, in a human resource information utilization system including a central server managing human resource information, the central server receives registration of an institution and individuals belonging to the institution as members, generates a unique ID for each individual who has performed a task in the institution, receives human resource information from the institution at each preset interval, classifies the human resource information into information on basic tasks and projects performed by the individual by analyzing the human resource information, and constructs a database to store the classified information on basic tasks and projects together with the corresponding unique ID of each individual.

According to various embodiments of the present disclosure, in a human resource utilization system including a central server managing human resource information, the central server receives, from an institution, human resource information related to an individual belonging to the institution at each preset interval, determines achievements at each step of a project performed by the individual against a project plan by analyzing the human resource information, determines a final evaluation score of the project performed by the individual by summing achievements at each step of the project against the project plan, and generates a human resource history of the individual including the final evaluation score of the project, wherein the achievements at each step of the project against the project plan may be determined based on at least one of an evaluation score by a successor, evaluation grounds, and a performance history.

According to various embodiments of the present disclosure, in a human resource information utilization system including a central server managing human resource information, the central server receives, from an institution, human resource information related to an individual belonging to the institution at each preset interval, generates a human resource history of the individual by analyzing the human resource information, generates encryption data corresponding to the human resource history of the individual, stores the generated encryption data to the central server and a node server of a blockchain network, and if the institution detects an input requesting an inquiry about the human resource history of the individual, determines falsification or forgery of the human resource history of the individual by comparing the encryption data stored in the central server with the encryption data stored in the node server.

According to various embodiments of the present disclosure, in a human resource information utilization system including a central server managing human resource information and generating HR coins, the central server receives human resource information from the institution or an individual belonging to the institution, checks evaluation scores related to basic tasks and a project of the individual by analyzing the human resource information, generates a human resource history of the individual based on the checked evaluation scores, and provides HR coins to participants related to the evaluation scores.

### Advantageous Effects

The human resource information utilization system according to the present disclosure may construct a database by acquiring information on an individual's basic tasks and projects from an institution to which the individual belongs and provide human resource information which is more credible and contains more information than existing systems.

Also, highly credible human resource information may be provided as a final evaluation score of a project is obtained from analysis of human resource information.

Also, false or forged human resource information may be checked easily by storing encryption data related to human resource information in a blockchain network.

Also, abundant human resource information may be obtained by providing a reward (for example, HR coins) to an institution or an individual who registers human resource information to the system of the present disclosure.

### BRIEF DESCRIPTION OF THE DRAWINGS

FIG. 1 is a block diagram illustrating a human resource information utilization system according to one embodiment of the present disclosure.

FIG. 2 is a flowchart illustrating a method for collecting human resource information according to one embodiment of the present disclosure.

FIG. 3 is a flowchart illustrating a method for storing human resource information according to retirement or job change in one embodiment of the present disclosure.

FIG. 4 is a flowchart illustrating a method for evaluating human resource information according to one embodiment of the present disclosure.

FIG. 5 is a flowchart illustrating a method for updating a human resource history according to basic tasks in one embodiment of the present disclosure.

FIG. 6 is a flowchart illustrating a method for determining falsification or forgery of human resource information according to one embodiment of the present disclosure.

FIG. 7 is a flowchart illustrating a method for rewarding a subject providing human resource information according to one embodiment of the present disclosure.

### DESCRIPTION OF EXEMPLARY EMBODIMENTS

According to an aspect of the present disclosure, a human resource utilization system including a central server managing human resource information is proposed, wherein the central server receives registration of an institution and individuals belonging to the institution as members, generates a unique ID for each individual who has performed a task in the institution, receives human resource information from the institution at each preset interval, classifies the human resource information into information on basic tasks and projects performed by the individual by analyzing the human resource information, and constructs a database to store the classified information on basic tasks and projects together with the corresponding unique ID of each individual.

In what follows, preferred embodiments of the present disclosure will be described in detail with reference to appended drawings. In describing the embodiments of the present disclosure, if it is determined that a detailed description of known functions or configurations incorporated herein unnecessarily obscure the gist of the present disclosure, the detailed description thereof will be omitted. The terms described below are defined considering the functions of the present disclosure, which may vary depending on the user or the operator's intention or practice. Therefore, the terms should be defined based on their context throughout the present disclosure.

The preferred embodiments of a human resource utilization system according to the present disclosure are described below with reference to appended drawings. However, the present disclosure is not limited to the embodiments disclosed below but may be implemented in various other forms; the present embodiments are provided simply to make the present disclosure complete and inform those skilled in the art clearly of the technical scope of the present disclosure.

Various embodiments of the present disclosure may be implemented by software (for example, program) including commands stored in a machine (for example, computer)-readable storage medium. The machine is a device capable of calling stored commands from the storage medium and operating according to the commands called, which may include an electronic device (for example, a server) according to the disclosed embodiments. The command may include code generated or executed by a compiler or an interpreter. The machine-readable storage medium may be provided in the form of a non-transitory storage medium. Here, the term ‘non-transitory’ only indicates that the storage medium does not include a signal and is tangible but does not distinguish whether data are stored semi-permanently or temporarily.

According to one embodiment, the method according to various embodiments of the present disclosure may be provided by being included in a computer program product. The computer program product may be traded between sellers and buyers as a commodity. The computer program product may be distributed in the form of a machine-readable storage medium (for example, a Compact Disc Read Only Memory (CD-ROM)) or online through an application store (for example, Play Store™). In the case of online distribution, at least part of the computer program product may be at least stored temporarily in a server of the manufacturer, a server of the application store, or a storage medium such as a memory of a relay server; or generated temporarily.

Each of the constituting elements (for example, a module or a program) according to various embodiments of the present disclosure may be composed of a single or multiple entities; and part of the corresponding sub-elements described above may be omitted, or another sub-element may be further included in the various embodiments. Alternatively or additionally, part of the constituting elements (for example, a module or a program) may be integrated into a single entity, and the functions executed by the respective constituting elements prior to the integration may be performed in the same manner or in a similar manner. The operations executed by a module, a program, or another constituting element according to the various embodiments may be performed in a sequential, parallel, or heuristic manner; or at least part of the operations may be performed in a different order or omitted, or another operation may be added to the operations.

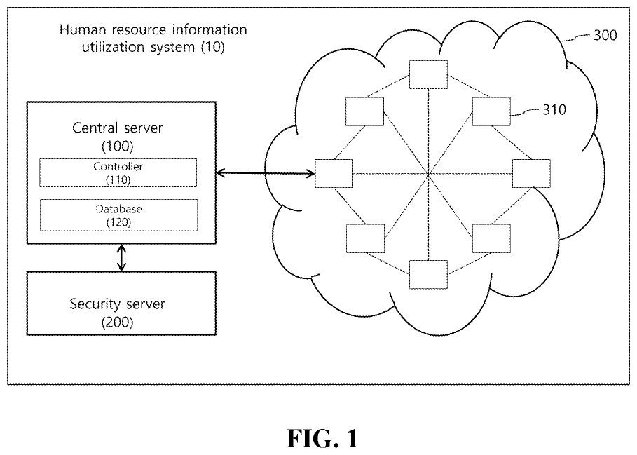

FIG. 1 is a block diagram illustrating a human resource information utilization system according to one embodiment of the present disclosure.

Referring to FIG. 1, a human resource information utilization system 10 according to the present disclosure may acquire human resource information from an institution or an individual and provide a highly credible human resource history of the individual based on the acquired human resource information. Here, an institution may refer to an organization hiring more than one employee, such as a company or a school. Here, an individual may refer to an employee belonging to one institution or a person seeking a job position. Here, human resource information may include information on basic tasks related to an individual (for example, preparation for a weekly meeting or a monthly meeting), project information (for example, results from the respective project steps performed by the individual), and the individual's basic personal information.

In one embodiment, the human resource information utilization system 10 may be composed of a central server 100, a security server 200, and a blockchain network 300. The central server 100 may provide an overall platform of the present system. For example, the central server 100 may provide a platform receiving registration of human resource information from an institution or an individual or a platform providing a highly credible human resource history of an individual by using the registered human resource information. For example, a controller 110 may control the overall operation for utilizing human resource information, and a database 120 may store acquired human resource information. The security server 200 may separately store information requiring security (for example, an individual's resident registration number or address) from among the human resource information. Also, differently from the aforementioned case, the security server 200 may store all of the human resource information.

In one embodiment, the blockchain network 300 may be composed of a plurality of node servers 310. Receiving encryption data related to the human resource information from the central server 100, the plurality of node servers 310 belonging to the blockchain network 300 may generate a block including the encryption data, add the generated block to the blockchain, and share the added blockchain among the plurality of node servers 310. Here, a blockchain may refer to a bundle of human resource information.

In one embodiment, the central server 100 and the blockchain network 300 may be connected to each other for communication through a network. Here, the network may include a wireless network and a wired network. For example, the network may be a short-range communication network (for example, Bluetooth, WiFi direct, or Infrared Data Association (IrDA)) or a long-range communication network (for example, a cellular network, Internet, or a computer network (for example, LAN or WAN)).

In one embodiment, institutions and individuals may be entities performing their business or work without being limited to any particular place in the world. For example, an institution's business area and an individual's workplace may be any place in the world.

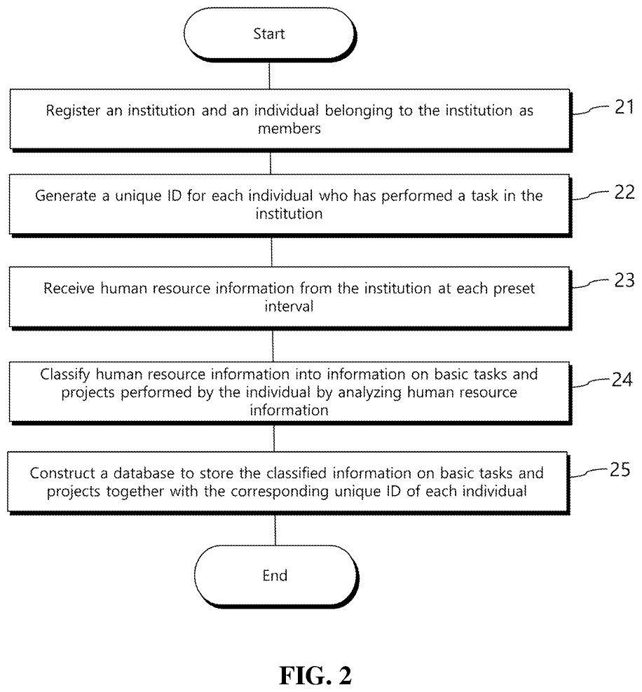

FIG. 2 is a flowchart illustrating a method for collecting human resource information according to one embodiment of the present disclosure. The operations of FIG. 2 may be performed by the central server 100 of FIG. 1.

Referring to FIG. 2, in one embodiment, the human resource utilization system 10 may receive registration of an institution and individuals belonging to the institution as members at the operation 21. For example, an institution or an individual may sign up for membership through a web page or an application screen provided by the central server 100. As the institution or the individual is registered as a member, the institution or the individual may use the platform to provide or obtain human resource information. For example, the institution may provide all of the results from the respective project steps performed by the individual and may receive a human resource history containing a plurality of projects performed by the individual. For example, the individual may directly enter the basic tasks or projects performed by the individual. The data entered by the individual may be cross-checked against the data entered by the institution to be validated for its credibility.

In one embodiment, at the operation 22, the human resource information utilization system 10 may generate a unique ID for each individual who has performed a task in the institution. For example, the human resource information obtained by the institution or the individual may be stored with the corresponding individual's unique ID as a key. For example, the unique ID may be an index value by which basic tasks and projects of the corresponding individual are distinguished. Therefore, through the individual's unique ID, the individual's whole work performance history may be checked, where the history may be a human resource history of the individual as described below.

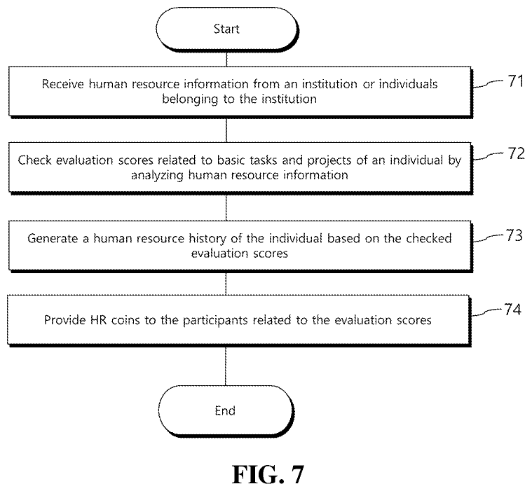

In one embodiment, at the operation 23, the human resource information utilization system 10 may receive human resource information from the institution at each preset interval. For example, the institution may preset the period for inputting human resource information, such as quarterly periods or semi-annual periods and may input human resource information of all individuals belonging to the institution every preset period through a platform provided by the central server 100. For example, the individuals providing human resource information may be employees who have agreed to provide human resource information through the institution. By giving consent, the employees may receive HR coins as a reward, which will be described with reference to FIG. 7 below.

In one embodiment, at the operation 24, the human resource information utilization system 10 may classify human resource information into information on basic tasks and projects performed by an individual by analyzing the human resource information. For example, the information on basic tasks may include tasks (for example, writing daily logs or handling expenses) performed periodically, such as daily or weekly tasks, and the information on projects may include performance results from the respective steps of a plurality of projects performed by the individual, a final performance result, and project group code.

In one embodiment, at the operation 25, the human resource information utilization system 10 may construct a database to store the classified information on basic tasks and projects together with the corresponding unique ID of each individual. For example, an individual does not necessarily perform tasks only at the current institution but may continue to work at another institution through retirement or job change. Therefore, since an individual's human resource history has to be managed on an individual basis even if the individual's affiliation is changed, information on basic tasks and information on projects may be stored together with the unique ID of the individual. In addition, through the unique ID of an individual, a plurality of projects performed by the corresponding individual may be identified, and each project may be identified through a project group code.

By performing the operations described above, the system 10 according to the present disclosure may collect highly credible human resource information.

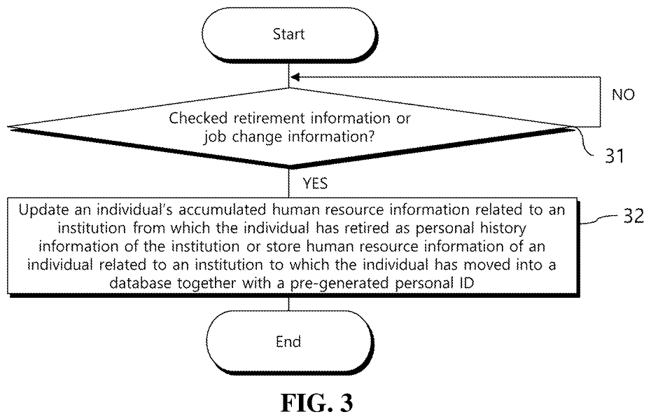

FIG. 3 is a flowchart illustrating a method for storing human resource information according to retirement or job change in one embodiment of the present disclosure. The operations of FIG. 3 may be performed by the central server 100 of FIG. 1.

Referring to FIG. 3, in one embodiment, at the operation 31, the human resource information utilization system 10 may check retirement information or job change information of an individual by analyzing human resource information. For example, an institution may register information of retired individuals or job changers every preset period through the platform of the system 10 of the present disclosure.

In one embodiment, at the operation 32, the human resource information utilization system 10 may update an individual's accumulated human resource information related to an institution from which the individual has retired as personal history information of the institution or store human resource information of an individual related to an institution to which the individual has moved into a database together with a pre-generated personal ID. For example, in the occurrence of retirement, the central server 100 may store human resource information that a retired person has generated during the employment in his or her institution as history information of the corresponding institution, which may be included in a human resource history of the person. Therefore, institutions using the system 10 of the present disclosure may separately check only the human resource information related to an institution from which the corresponding individual has retired. Also, as human resource information of an individual to be newly generated in an institution to which the individual has moved is also stored using a pre-generated unique ID, the individual's human resource history may include all of the human resource information of the corresponding individual regardless of change of institutions.

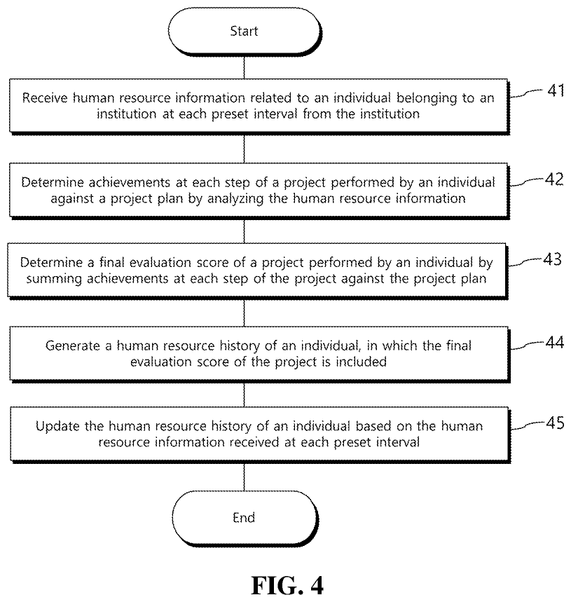

FIG. 4 is a flowchart illustrating a method for evaluating human resource information according to one embodiment of the present disclosure. The operations of FIG. 4 may be performed by the central server 100 of FIG. 1.

Referring to FIG. 4, in one embodiment, at the operation 41, the human resource information utilization system 10 may receive human resource information related to an individual belonging to an institution at each preset interval from the institution. For example, the institution may preset the period for inputting human resource information, such as quarterly periods or semi-annual periods and may input human resource information of all individuals belonging to the institution every preset period through a platform provided by the central server 100.

In one embodiment, at the operation 42, the human resource information system 10 may determine achievements at each step of a project performed by an individual against a project plan by analyzing the human resource information. For example, the human resource information may include information on a project currently being performed or completed by the individual. Here, project information may include intermediate results at the respective steps of the project, final results, evaluation data for the respective steps, and evaluation data for the final results. Here, achievements at the respective steps against the project plan may be expressed in terms of evaluation scores or determined based on at least one of the evaluation score by a successor for the next step of the project, evaluation grounds, and a performance history.

In one embodiment, at the operation 43, the human resource information utilization system 10 may determine a final evaluation score of a project performed by an individual by summing achievements at each step of the project against the project plan. For example, the central server 100 may sum all of the performance index designated by a project supervisor, evaluation of compliance with a project schedule in each step, and evaluation by a successor according to the project process; and determine a final evaluation score from averaging thereof.

Meanwhile, in one embodiment, if any one of a plurality of steps of the corresponding project fails the evaluation by the successor or evaluation by the successor is missing, the central server 100 may set the evaluation score of the corresponding project to the minimum. Therefore, the system 10 of the present disclosure may guide all of individuals participating in a project to voluntarily improve their performance for conducting the project so that a high evaluation score may be obtained.

In one embodiment, the central server 100 may determine a final evaluation score of the project by additionally considering at least one of the supervisor's evaluation of the project result, evaluation by customers related to the project, degree of difficulty of the project, and the level of the institution to which individuals belong. Here, degree of difficulty of the project may refer to the grade of the corresponding project, and the level of the institution may be determined by considering sales, net profit, proportion of sales in the corresponding field against competing companies, amount of R&D investment, and patent portfolio in a comprehensive manner.

Meanwhile, in one embodiment, the central server 100 may determine the final evaluation score of the project by additionally considering at least one of attendance and tardiness records of an individual, task handling speed, promotion speed, and capability upgrade of the individual, and training courses completed by the individual.

In one embodiment, at the operation 44, the human resource information utilization system 10 may generate a human resource history of an individual, in which the final evaluation score of the project is included. For example, the central server 100 may include all of information on a plurality of projects performed by an individual and generate the human resource history of the individual, which may be retrieved by a recruiting institution. Here, the human resource history may include all of information related to basic tasks and a plurality of projects performed by an individual in an institution.

In one embodiment, at the operation 45, the human resource information utilization system 10 may update the human resource history of an individual based on the human resource information received at each preset interval. For example, according to the human resource information updated periodically, the central server 100 may update the human resource history and provide the most recently updated human resource history to a recruiting institution.

In one embodiment, although not shown in the figure, the system 10 of the present disclosure may not only update the human resource history but also recommend an optimal task or project suitable for an individual by analyzing the individual's project performance pattern and achievements; and recommend a right person to a recruiting institution.

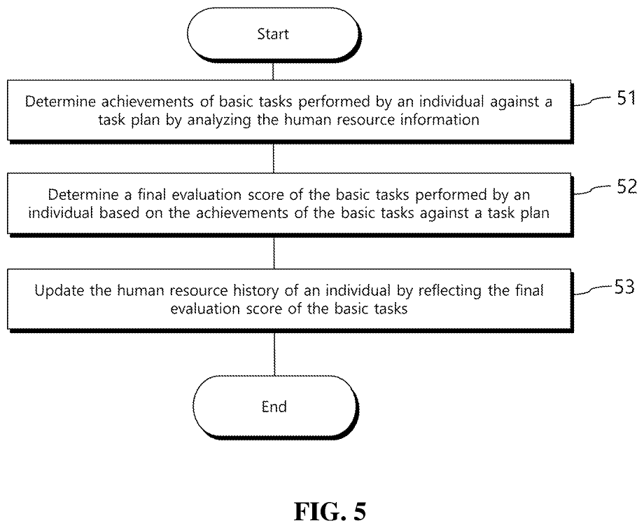

FIG. 5 is a flowchart illustrating a method for updating a human resource history according to basic tasks in one embodiment of the present disclosure. The operations of FIG. 5 may be performed by the central server 100 of FIG. 1.

Referring to FIG. 5, in one embodiment, at the operation 51, the human resource information utilization system 10 may determine achievements of basic tasks performed by an individual against a task plan by analyzing the human resource information. For example, the basic tasks may refer to the tasks performed periodically, such as daily or weekly tasks performed by an individual (for example, writing daily logs or handling expenses). For example, the achievements of basic tasks against a task plan may be determined based on at least one of evaluation by a person involved in the basic tasks, evaluation by an approving person of the basic tasks, and evaluation by customers related to the basic tasks.

In one embodiment, at the operation 52, the human resource information utilization system 10 may determine a final evaluation score of the basic tasks performed by an individual based on the achievements of the basic tasks against a task plan. Also, the final evaluation score of the basic tasks may be determined by additionally considering at least one of attendance and tardiness records of an individual, task handling speed, promotion speed, and capability upgrade of the individual, and training courses completed by the individual.

In one embodiment, at the operation 53, the human resource information utilization system 10 may update the human resource history of an individual by reflecting the final evaluation score of the basic tasks. Therefore, the individual's human resource history may continuously reflect the evaluation scores of basic tasks and projects performed by the individual.

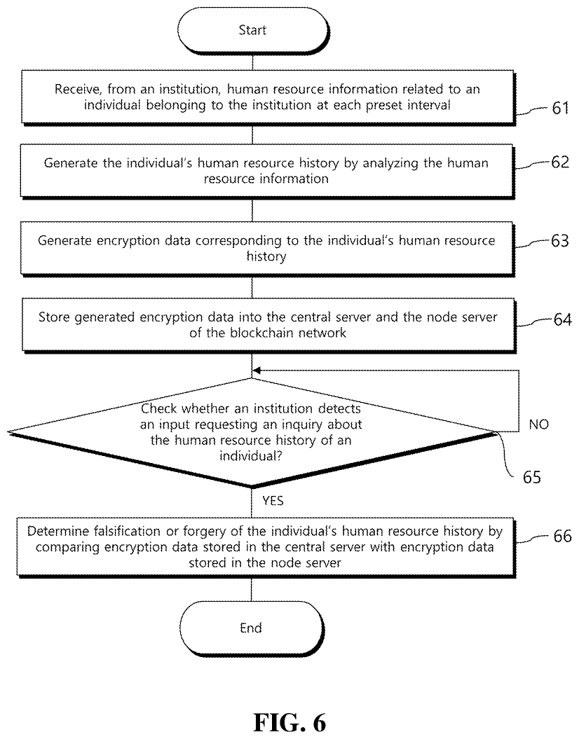

FIG. 6 is a flowchart illustrating a method for determining falsification or forgery of human resource information according to one embodiment of the present disclosure. The operations of FIG. 6 may be performed by the central server 100 of FIG. 1.

Referring to FIG. 6, in one embodiment, at the operation 61, the human resource information utilization system 10 may receive, from an institution, human resource information related to an individual belonging to the institution at each preset interval.

In one embodiment, at the operation 62, the human resource information utilization system 10 may generate the individual's human resource history by analyzing the human resource information.

In one embodiment, at the operation 63, the human resource information utilization system 10 may generate encryption data corresponding to the individual's human resource history. For example, the central server 100 may encrypt and store an evaluation score by a successor, evaluation grounds, a performance history, evaluation by a person involved in the basic tasks, evaluation by an approving person of the basic tasks, and evaluation by customers related to the basic tasks and generate encryption data based thereupon. The encryption data may include hash code generated based on the human resource history. Also, the encryption data may include a unique identification code generated based on the human resource history and basic data. Here, basic data may include personal information of the individual and summary data of basic tasks and projects performed by the individual. Differently from the aforementioned case, the encryption data may include the whole information of the human resource history.

Meanwhile, in one embodiment, the central server 100 may store encryption data in the security server 200.

In one embodiment, at the operation 64, the human resource information utilization system 10 may store generated encryption data into the central server 100 and the node server 310 of the blockchain network 300. For example, the central server 100 may generate N-th encryption data corresponding to the N-th updated human resource history of an individual, store the N-th encryption data into the central server 100 and the N-th node server of the blockchain network 300, generate (N+1)-th encryption data corresponding to the (N+1)-th updated human resource history of the individual, and store the (N+1)-th encryption data into the central server 100 and the (N+1)-th node server of the blockchain network 300. Therefore, the encryption data may be blockchained in the blockchain network 300.

In one embodiment, at the operation 65, the human resource information utilization system 10 may check whether an institution detects an input requesting an inquiry about the human resource history of an individual.

In one embodiment, when the institution detects an input requesting an inquiry about the human resource history of an individual, at the operation 66, the human resource information utilization system 10 may determine falsification or forgery of the individual's human resource history by comparing the encryption data stored in the central server with the encryption data stored in the node server 310. For example, when the hash code stored in the central server 100 does not coincide with the hash code stored in the node server 310, the central server 100 may determine that the corresponding human resource history has been falsified or forged. Also, differently from the aforementioned case, when the unique identification code stored in the central server 100 does not coincide with the unique identification code stored in the node server 310, the central server 100 may determine that the corresponding human resource history has been falsified or forged.

FIG. 7 is a flowchart illustrating a method for rewarding a subject providing human resource information according to one embodiment of the present disclosure. The operations of FIG. 7 may be performed by the central server 100 of FIG. 1.

Referring to FIG. 7, in one embodiment, at the operation 71, the human resource information utilization system 10 may receive human resource information from an institution or individuals belonging to the institution.

In one embodiment, at the operation 72, the human resource information utilization system 10 may check evaluation scores related to basic tasks and projects of an individual by analyzing human resource information.

In one embodiment, at the operation 73, the human resource information utilization system 10 may generate a human resource history of the individual based on the checked evaluation scores.

In one embodiment, at the operation 74, the human resource information utilization system 10 may provide HR coins to the participants related to the evaluation scores. For example, the participants may include at least one of a successor of each project step, a supervisor for a final result of the project, customers related to the project, a person involved in the basic tasks of an individual, an approving person of the basic tasks, customers related to the basic tasks, and an individual or an institution which has entered the human resource information. The system 10 of the present disclosure may reward each activity of the participant, such as the activity of entering information through a given platform, using HR coins and encourage participation through the reward.

According to various embodiments of the present disclosure, in a human resource information utilization system including a central server managing human resource information, the central server may receive registration of an institution and individuals belonging to the institution as members, generate a unique ID for each individual who has performed a task in the institution, receive human resource information from the institution at each preset interval, classify the human resource information into information on basic tasks and projects performed by the individual by analyzing the human resource information, and construct a database to store the classified information on basic tasks and projects together with the corresponding unique ID of each individual.

According to various embodiments, when the individual's retirement information is checked from analysis of the human resource information, the central server may update the individual's accumulated human resource information related to an institution from which the individual has retired as personal history information of the institution.

According to various embodiments, when the individual's job change information is checked from analysis of the human resource information, the central server may store the individual's human resource information related to an institution to which the individual has moved into the database together with a pre-generated unique ID.

According to various embodiments, the central server may receive human resource information from individuals belonging to the institution.

According to various embodiments of the present disclosure, in a human resource information utilization system including a central server managing human resource information, the central server may receive, from an institution, human resource information related to an individual belonging to the institution at each preset interval, determine achievements at each step of a project performed by the individual against a project plan by analyzing the human resource information, determine a final evaluation score of the project performed by the individual by summing achievements at each step of the project against the project plan, and generate a human resource history of the individual including the final evaluation score of the project, wherein the achievements at each step of the project against the project plan may be determined based on at least one of an evaluation score by a successor, evaluation grounds, and performance history.

According to various embodiments, the central server may determine a final evaluation score of the project by additionally considering at least one of a supervisor's evaluation of the project result, evaluation by customers related to the project, degree of difficulty of the project, and level of the institution to which individuals belong.

According to various embodiments, the central server may determine achievements of basic tasks performed by an individual against a task plan by analyzing the human resource information, determine a final evaluation score of the basic tasks performed by the individual based on the achievements of the basic tasks against the task plan, and updates a human resource history of the individual by reflecting the final evaluation score of the basic tasks, wherein the achievements of the basic tasks against the task plan may be determined based on at least one of evaluation by a person involved in the basic tasks, evaluation by an approving person of the basic tasks, and evaluation by customers related to the basic tasks.

According to various embodiments, the central server may update the human resource history of the individual based on the human resource information received at each preset interval.

According to various embodiments, the central server may determine the final evaluation score of the project or final evaluation score of the basic tasks by additionally considering at least one of attendance and tardiness records of an individual, task handling speed, promotion speed, and capability upgrade of the individual, and training courses completed by the individual.

According to various embodiments, the central server may encrypt and store the evaluation score by a successor, the evaluation grounds, the performance history, the evaluation by a person involved in the basic tasks, the evaluation by an approving person of the basic tasks, and the evaluation by customers related to the basic tasks.

According to various embodiments of the present disclosure, in a human resource information utilization system including a central server managing human resource information, the central server may receive, from an institution, human resource information related to an individual belonging to the institution at each preset interval, generate a human resource history of the individual by analyzing the human resource information, generate encryption data corresponding to the human resource history of the individual, store the generated encryption data to the central server and a node server of a blockchain network, and if the institution detects an input requesting an inquiry about the human resource history of the individual, determine falsification or forgery of the human resource history of the individual by comparing the encryption data stored in the central server with the encryption data stored in the node server.

According to various embodiments, the central server may update the human resource history of the individual based on the human resource information updated at each preset interval, generate N-th encryption data corresponding to the N-th updated human resource history of the individual, store the N-th encryption data into the central server and the N-th node server of the blockchain network, generate (N+1)-th encryption data corresponding to the (N+1)-th updated human resource history of the individual, and store the (N+1)-th encryption data into the central server and the (N+1)-th node server of the blockchain network.

According to various embodiments, the human resource information utilization system may further include a security server, and the central server may store the encryption data into the security server.

According to various embodiments, the encryption data may include hash code generated based on the human resource history of the individual.

According to various embodiments, the encryption data may include a unique identification code generated based on the human resource history and basic data.

According to various embodiments of the present disclosure, in a human resource information utilization system including a central server managing human resource information and generating HR coins, the central server may receive human resource information from the institution or an individual belonging to the institution, check evaluation scores related to basic tasks and a project of the individual by analyzing the human resource information, generate a human resource history of the individual based on the checked evaluation scores, and provide HR coins to participants related to the evaluation scores.

According to various embodiments, the participants may include at least one of a successor of each project step, a supervisor for a final result of the project, customers related to the project, a person involved in the basic tasks of an individual, an approving person of the basic tasks, customers related to the basic tasks, and an individual or an institution which has entered the human resource information.

According to various embodiments of the present disclosure, a human resource information utilization method may comprise receiving registration of an institution and individuals belonging to the institution as members; generating a unique ID for each individual who has performed a task in the institution; receiving human resource information from the institution at each preset interval; classifying the human resource information into information on basic tasks and projects performed by the individual by analyzing the human resource information; constructing a database to store the classified information on basic tasks and projects together with the corresponding unique ID of each individual; determining achievements at each step of a project performed by the individual against a project plan by analyzing the human resource information; determining a final evaluation score of the project performed by the individual by summing achievements at each step of the project against the project plan; and generating a human resource history of the individual including the final evaluation score of the project, wherein the achievements at each step of the project against the project plan may be determined based on at least one of an evaluation score by a successor, evaluation grounds, and a performance history.

According to various embodiments of the present disclosure, a human resource information utilization method may comprise generating a unique ID for each individual who has performed a task in an institution; receiving human resource information from the institution at each preset interval; checking evaluation scores related to basic tasks and a project performed by an individual by analyzing the human resource information; generating a human resource history of the individual based on the checked evaluation scores; providing HR coins to the participants related to the evaluation scores; generating encryption data corresponding to the human resource history of the individual; storing the generated encryption data into the central server and a node server of a blockchain network; and if the institution detects an input requesting an inquiry about the human resource history of the individual, determining falsification or forgery of the human resource history of the individual by comparing the encryption data stored in the central server with the encryption data stored in the node server.

The present disclosure has been described with reference to specific constituting elements and a limited number of embodiments and drawings, which has been intended only to help overall understanding of the present disclosure. Therefore, the present disclosure is not limited to the specific embodiments, and various changes and modifications are possible from the descriptions by those skilled in the art to which the present disclosure belongs.

Therefore, the technical scope of the present disclosure should not be confined to that provided by the embodiments, and it should be noted that not only the appended claims but also all of those equivalent to the appended claims or modifications which may be regarded as being equal thereto belong to the technical scope of the present disclosure.

[Detailed Description of Main Elements]

10: Human resource information utilization system
100: Central server
110: Controller
120: Database
200: Security server
300: Blockchain network
310: Node server

### INDUSTRIAL AVAILABILITY

The present disclosure relates to a human resource information utilization system and a method for operating the system. The human resource information utilization system according to the present disclosure may construct a database by acquiring information on an individual's basic tasks and projects from an institution to which the individual belongs and, thus, provide human resource information which is more credible and contains more information than existing systems. The human resource information utilization system according to the present disclosure may be utilized in the field such as employment-related online platforms.

1. A human resource information utilization system comprising a central server managing human resource information, the central server configured to:
receive registration of an institution and individuals belonging to the institution as members;
generate a unique ID for each individual who has performed a task in the institution;
receive human resource information from the institution at each preset interval;
classify the human resource information into information on basic tasks and projects performed by the individual by analyzing the human resource information;
construct a database to store the classified information on basic tasks and projects together with the corresponding unique ID of each individual;
update the individual's accumulated human resource information related to an institution from which the individual has retired as personal history information of the retired institution if an individual's retirement information is checked by analyzing the human resource information;
store the individual's human resource information related to an institution to which the individual has moved into a database together with a pre-generated unique ID of the individual if an individual's turnover information is checked by analyzing the human resource information;
determine achievements at each step of a project performed by the individual against a project plan, based on an evaluation score by a successor, evaluation grounds, and a performance history which are checked from the human resource information;
determine level of the institution based on sales, net profit, proportion of sales in the corresponding field against competing companies, amount of R&D investment, and patent portfolio of the institution;
determine a final evaluation score of the project performed by the individual based on the performance index designated by a project supervisor, evaluation of compliance with a project schedule in each step, evaluation by a successor according to the project process, a supervisor's evaluation of the project result, evaluation by customers related to the project, and level of the institution;
set the final evaluation score of the project to the minimum if the evaluation by the successor for any one of a plurality of steps of the project is a fail or missing;
determine achievements of basic tasks performed by an individual against a task plan based on evaluation by a person involved in the basic tasks, evaluation by an approving person of the basic tasks, and evaluation by customers related to the basic tasks which are checked from the human resource information;
determine a final evaluation score of the basic tasks performed by the individual based on the achievements of basic tasks;
update a human resource history of the individual by reflecting the final evaluation score of the project and the final evaluation score of the basic tasks; and
provide HR coins to the participants related to the evaluation scores,
wherein the participants include a successor of each project step, a supervisor for a final result of the project, customers related to the project, a person involved in the basic tasks of an individual, an approving person of the basic tasks, customers related to the basic tasks, and an individual or an institution which has entered the human resource information.

2. (canceled)

3. (canceled)

4. The system of claim 1, wherein the central server receives human resource information from an individual belonging to the institution.

5. (canceled)

6. (canceled)

7. (canceled)

8. The system of claim 1, wherein the central server updates the human resource history of the individual based on the human resource information received at each preset interval.

9. (canceled)

10. The system of claim 1, wherein the central server encrypts and stores an evaluation score by a successor, the evaluation grounds, the performance history, evaluation by a person involved in the basic tasks, evaluation by an approving person of the basic tasks, and evaluation by customers related to the basic tasks

11. (canceled)

12. (canceled)

13. (canceled)

14. (canceled)

15. (canceled)

16. (canceled)

17. (canceled)

18. (canceled)

19. (canceled)
